(19) United States
(12) Patent Application Publication
(10) Pub. No.: US 2016/0379031 A1
(43) Pub. Date: Dec. 29, 2016

(54) HIGH CAPACITY 2D COLOR BARCODE DESIGN AND PROCESSING METHOD FOR CAMERA BASED APPLICATIONS

(71) Applicant: KONICA MINOLTA LABORATORY U.S.A., INC., San Mateo, CA (US)

(72) Inventor: Gang Fang, San Bruno, CA (US)

(73) Assignee: KONICA MINOLTA LABORATORY U.S.A., INC., San Mateo, CA (US)

(21) Appl. No.: 14/747,342

(22) Filed: Jun. 23, 2015

(51) Int. Cl. G06K 7/14

(52) U.S. Cl. CPC G06K 7/1417; G06K 7/1426; G06K 7/1443

(57) ABSTRACT

A processing method for a color barcode image captured by a camera or barcode reader. The barcode includes color data cells and multiple large black locators which are located at the four corners of the barcode, along the four borders, and inside the barcode forming an array. The locators are first identified from a grayscale version of the barcode image using multiple binarization technique to ensure that all locators are identified. Perspective correction and illumination correction may be applied to the barcode image using the identified locators.

### BACKGROUND OF THE INVENTION

Field of the Invention

This invention relates to the design and decoding of two-dimensional (2D) color barcode, and in particular, it relates to the design and decoding of 2D color barcode for camera based applications.

Description of Related Art

Barcode is an optical machine-readable representation of data. A 2D color barcode is formed of small square or rectangular cells arranged in a two-dimensional manner, e.g., in both horizontal and vertical directions, and one color is used for each cell. Different colors represent different data values. The relation between the data capacity of the barcode and the cell number and the number of colors can be expressed as

Data capacity=(Cell Number)×log₂(Num of color representations)

A barcode design that uses small cell sizes and more color representations can achieve a relatively high data capacity in a given area. However, various factors limit how small cells can be.

When a 2D color barcode is printed on paper or displayed on a display screen such as the screen of a mobile device, and read by a camera-based barcode reader (as opposed to a flat-bed type scanner), perspective projection and non-uniform illumination may present a challenge for decoding the barcode.

### SUMMARY

Accordingly, the present invention is directed to a method and related apparatus of processing a 2D color barcode that substantially obviates one or more of the problems due to limitations and disadvantages of the related art.

An object of the present invention is to provide a method to accurately identify the locators in the barcode image.

Another object of the present invention is to provide corrections for perspective projection and non-uniform illumination for barcode image acquired by a camera based barcode reader.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for processing a two-dimensional color barcode in a captured barcode image, the barcode having a known layout including a plurality of color data cells and a plurality of locators each formed of a plurality of black pixels, the locators being located at different positions throughout the barcode, the method including: converting the color barcode image into a grayscale barcode image; binarizing the grayscale barcode image a plurality of times, each time using one of a plurality of different binarization thresholds, to generate a plurality of binary images; identifying locators in each binary image and determining their positions; and combining the locators identified in the plurality of binary images to generate a combined list of locators.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a color barcode layout according to an embodiment of the present invention.

FIG. 2 schematically illustrates a method for processing a barcode image according to an embodiment of the present invention.

FIG. 3A illustrates an exemplary barcode image.

FIGS. 3B-3E illustrate multiple binary images generated from the barcode image in FIG. 3A using different binarization thresholds.

FIG. 4 schematically illustrates a method for identifying locators in a binary image according to an embodiment of the present invention.

FIG. 5 schematically illustrates a data processing apparatus in which embodiments of the present invention may be implemented.

### DETAILED DESCRIPTION OF PREFERRED EMBODIMENTS

An aspect of the present invention is the layout design of a 2D color barcode which will be printed on media or shown on a screen of a mobile device. Another aspect of the present invention is a decoding process and algorithm suitable for decoding 2D color barcode from images captured via a camera. The design of the 2D color barcode contains features that facilitate the processing and decoding from camera-captured barcode images.

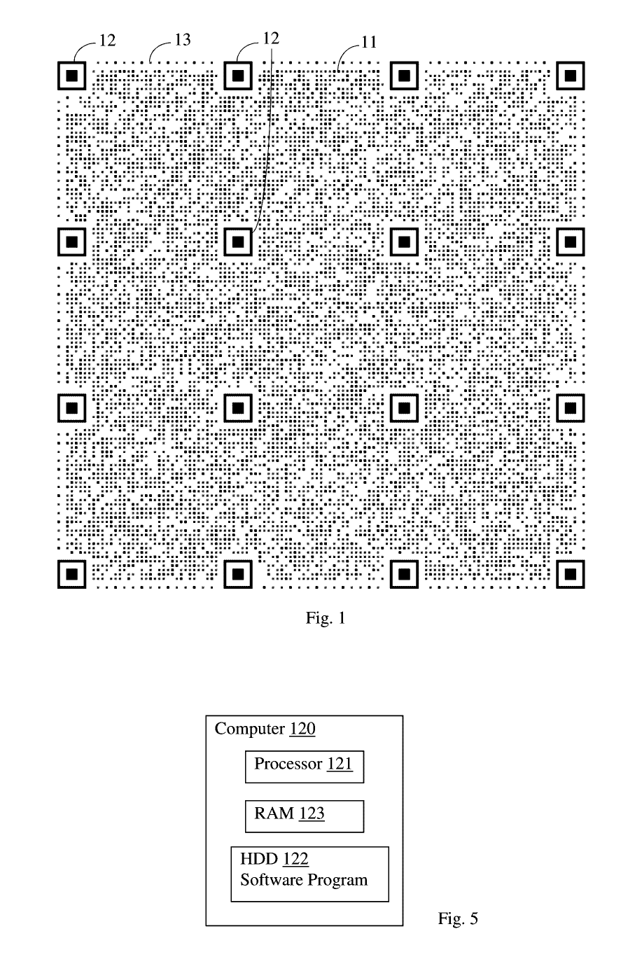

FIG. 1 depicts the layout of an exemplary color barcode according to an embodiment of the present invention. The color barcode includes a plurality of data cells 11 forming a two-dimensional array, each cell having one of a plurality of colors. In a preferred embodiment, the plurality of colors are cyan (C), magenta (M), white (W) (i.e., unprinted), and black (K), and each cell can represent 2 bits of information. CMYK are the primary colors used in typical printers, and each of them is printed by one colored ink and referred to as a color channel. In the color barcode layout of FIG. 1, the primary color yellow (Y) is replaced with white (W), i.e., unprinted cells. Therefore, each cell in the barcode is printed with one ink or unprinted, and the color of each cell will be uniform. Each cell has a defined size, and cells are separated by defined distances. Preferably the cells are square shaped, form columns and rows that are aligned in the vertical and horizontal directions on a grid, and the row distance and column distance are equal. In one particular embodiment, the cell size is 3×3 pixels and the distance (the width of the white space) between cells is 2 pixels in both horizontal and vertical directions. In this example, the grid is a square grid. Alternatively, the grid may be a rectangular grid.

The barcode has a plurality of locators 12 located at the four corners of the barcode, along the borders of the barcode, as well as in the interior of the barcode. In the illustrated example, sixteen locators 12 are provided, forming a 4×4 array; four locators are located at the corners, eight are located along the borders, and four are located in the interior of the barcode. As will be seen later, the locators 12 can provide position reference within the whole barcode to aid image processing and decoding. The locators are preferably black and substantially larger than the data cells, which make them relatively easy to identify in the image. In the illustrate embodiment, each locator is formed by a solid black square surrounded by a white space and then a black border; the square is 13×13 pixels (i.e. as wide as three columns and three rows of data cells), the white space is 7 pixels wide (i.e.. equivalent to the white space created when a column or row of data cells are removed in the data cell area), and the black border is 3 pixels wide (i.e. the same width as the data cells). Thus, each collator 12 is 33×33 pixels in size and occupies the space equivalent to 7×7 data cells in the data cell array.

The barcode also has a plurality of border reference cells 13 located along the four borders of the barcode between the locators. The border reference cells 13 include cyan, magenta and black reference cells that are arranged in a predefined color sequence, e.g. a repeating sequence of C, M, B in the illustrated example. In other words, the color of each border reference cell is known. The reference cells can provide channel offset (global and local) information and color information that is useful in the decoding process. In one embodiment, the border reference cells 13 have the same size as the data cells 11, so that the color densities of these reference cells are similar to those of the data cells.

The border reference cells 13 are separated from each other, from the locators 12 and from the data cells 11 by larger distances than the cell separation in the inside data cell array in order to avoid the potential overlap of reference cells. In the illustrated example, the distance (the white space) between two adjacent reference cells, and between reference cells and adjacent data cells, is 7 pixels (i.e.. equivalent to the white space created when a column or row of data cells are removed in the data cell area). The locator 12 and the adjacent reference cells 13 are separated by this distance or a larger distance.

An asymmetry may be designed into the barcode so that one of the four locators in the corners can be distinguished from the others, which is useful in the decoding process. This may be achieved in any suitable ways. For example, one corner locator may have a different shape than the others. An asymmetry may also be designed into the barcode by using different or asymmetric color sequences of the reference cells along the borders. Other additional features may be designed into the barcode as well, such as verification cells that encode the data length and ECC of the barcode, etc.

In one particular example, the grid for a barcode has 124 columns and 124 rows. Excluding the white spaces, the locators and the reference cells, about 13500 data cells can be used to store information in each barcode. Multiple barcodes can be placed adjacent to each other on the same page with a white space of, for example, 20 pixels between them. For a print resolution of 600 dpi, a barcode will take about 1.05×1.05 square inches of space. Thus, up to 7×10 bar codes may be placed on a letter sized page.

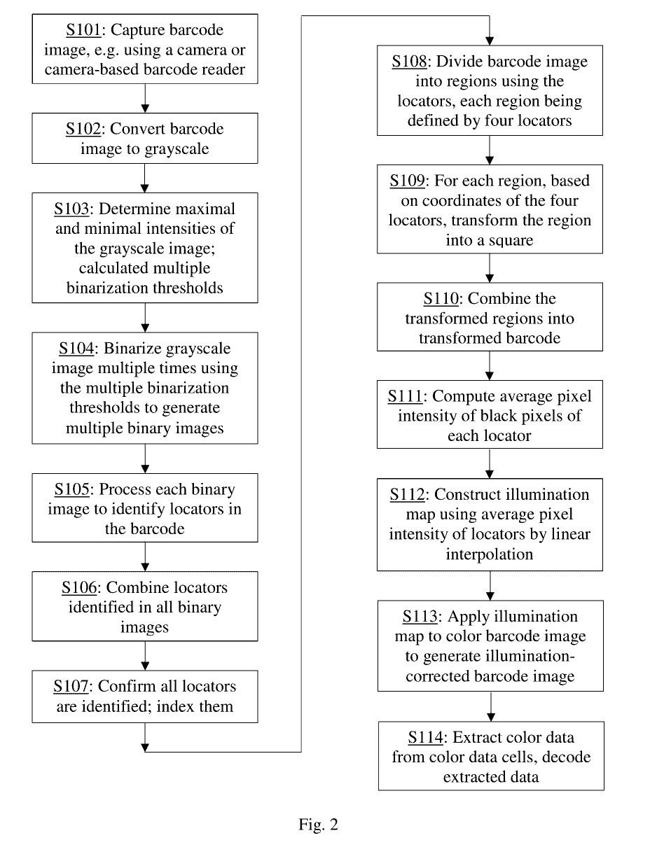

A barcode image processing method for processing a barcode having the above design is described below with reference to FIG. 2. First, a barcode image is captured (step S101). The barcode having the above-described layout design has been printed on paper or displayed on a display screen such as the screen of a mobile device. In this step, the barcode image, which is a color image, is typically captured using a camera or a camera-based barcode reader with the printed sheet or the screen held in front of the barcode reader or camera. Of course, the barcode image may also be captured using a scanner.

The captured image is converted to a grayscale image (step S102). The maximal and minimal intensities (pixel values) of the grayscale image are determined, and multiple binarization thresholds are calculated based on the maximal and minimal intensity values (step S103). Note here that due to imaging conditions, the pixel values for white space or white cells and for black cells in the captured image may not be the theoretical values for white and black. In one implementation, four binarization thresholds are calculated, and their values are linearly spread between the maximal and minimal intensity values. The grayscale barcode image is then binarized multiple times using the multiple binarization thresholds, to generate respective multiple binary images (step S104).

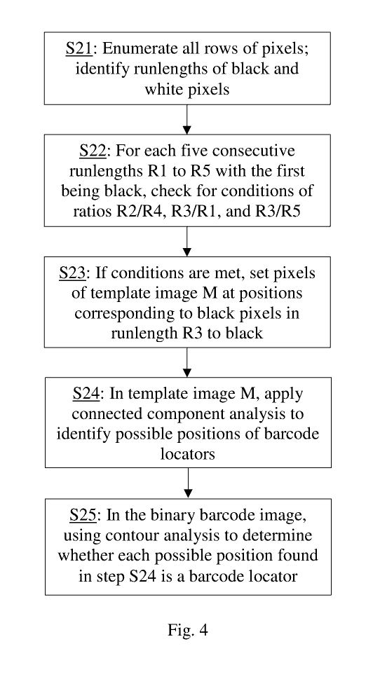

Each binary image is processed to identify the locators in the barcode (step S105). Any suitable techniques may be used to identify the locators, which have a known shape. The method may depend on the shape of the locators. For example, for the exemplary barcode design shown in FIG. 1, where the locators have the shape of concentric squares (a solid square surrounded by a square border with a white space in between), when a horizontal scan line passes through the center of a locator, the ratios among the neighboring black and white segment lengths (i.e. runlengths of black and white pixels) should fall in given ranges. Thus, these ratios may be used to identify locators. One example of a method for identifying locators in a binary image is described in detail below with reference to FIG. 4; it should be understood that the other methods may be used and the invention is not limited to these specific examples. While specific values are given in the example below, other suitable values may be used.

First, all rows of pixels in the binary image are enumerated; in each row, all runlengths of the black pixels (foreground) and the white pixels (background) are identified (step S21). For each five consecutive runlengths R1 to R5 with the first being black, the following ratios are calculated and compared to predetermined ranges: 0.5≦R2/R4≦2, 2≦R3/R1≦20, and 2≦R3/R5≦20 (step S22). If the above conditions are satisfied, the pixels of a template image M at the positions corresponding to black pixels in runlength R3 are set to black (step S23). The image M is a binary image having the same size as the binary barcode image, and all of its pixels are initially set to white.

After all rows of the binary barcode image are processed, the image M is analyzed to identify candidate positions that are possibly locators of the barcode image, using connected component analysis (step S24). First, the image M is analyzed to find all connected components in it. A connected component of a binary image is a group of black pixels connected to each other. For each connected component, if its height to width ratio is outside of the range of [0.5, 2], it is discarded. For the remaining connect components in the image M, their centers are identified as candidate positions which possibly correspond to locators of the barcode image.

Then, in the binary image for each candidate position identified in step S24, contour analysis is applied to determine whether it is a barcode locator (step S25). First, for each position corresponding to a center position identified in the image M, the binary image is analyzed to find contours around that position. If that position corresponds to a locator of the barcode, three contours should be found around it. Thus, if three contours are not found for a given position, that position is discarded. If three contours are found around a given position, the lengths of the three contours L1, L2, and L3 are obtained to determine whether they satisfy certain predetermined relations, such as: 0.3≦L1/L2≦0.7 and 0.4≦L1/L3≦0.95. If the above conditions are satisfied, this position is regarded as a barcode locator position. Then, from the binary image, the center of the connect components related to the first contour L1 is determined as is the center of that barcode locator.

Step S105 produces a list of positions (coordinates) of the identified locators. Preferably, the geometric center of each locator is used to define its position. The locators identified in all binary images are combined together to generate a combined list of locators (step S106). The purpose of the multiple binarization process, i.e. steps S103-S106, is to ensure that all locators in the image are identified. Due to various reasons, some locators may not be correctly identified in some of the binary images. For example, due to lighting and exposure conditions, the lightness of the barcode image may be uneven across the entire barcode; for a given binarization threshold, some regions of the barcode image may be too light and/or some regions may be too dark, and the locators in these regions may not be correctly identified. By using multiple binarization, it can be expected that each locator will be correctly identified in some of the binary images, so the combined list of locators generated in step S106 will contain all of the locators in the barcode. Some locators may be identified in multiple binary images; in step S106, the coordinates of the locators in the multiple lists generated in step S105 are compared to determine whether some items in different lists correspond to the same locators.

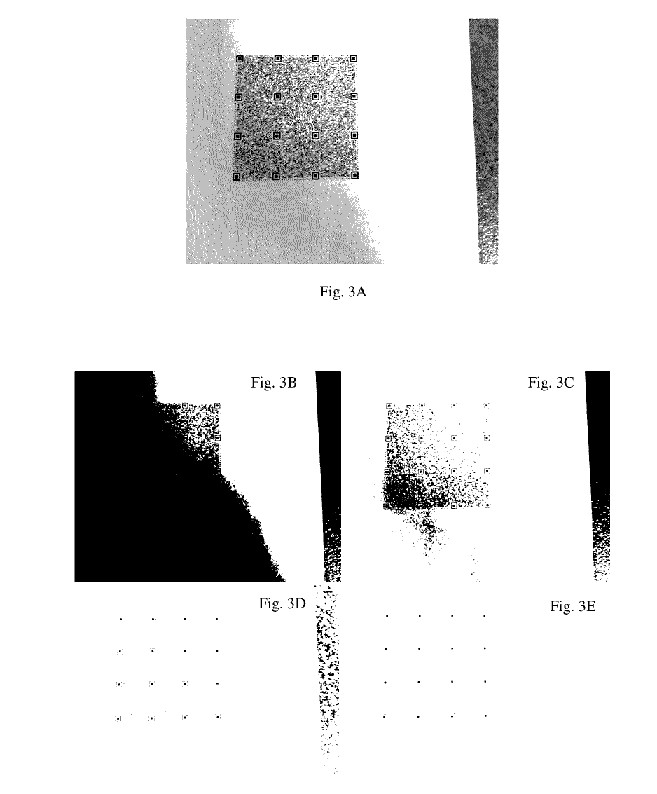

An example is shown in FIGS. 3A-3E. FIG. 3A illustrates an exemplary barcode image. FIGS. 3B-3E illustrate multiple binary images generated from the barcode image in FIG. 3A using different binarization thresholds. In this example, the lower-left hand part of the barcode image (FIG. 3A) is darker than the upper-right hand part. It can be seen that some locators are more clearly visible in some binary images than others, and all of them can be identified in at least one binary image.

The combined list of locators is checked to confirm that the number of locators is equal to the desired number (e.g. sixteen); if confirmed, the locators in the list are indexed based on their position in the barcode (step S107). For example, they may be indexed from the top row to the bottom row and in each row from the left column to the right column, and assigned index values from 1 to 16. Note that the barcode can have any orientation in the image; the choice of how the locators are indexed is essentially arbitrary.

The identified locators can be used in subsequent processing of the barcode image, such as correction of perspective distortions, correction of illumination effect, barcode data extraction, etc.

Because the barcode image is captured using a barcode reader or camera, the printed sheet or mobile screen on which the barcode is printed or displayed may have been held at an angle with respect to the barcode reader or camera. As a result the barcode in the image are often not a square but contains perspective distortion. Correction of perspective distortion is performed for the barcode image in steps S108-S110. This process is performed on the original color image of the barcode using the locators identified in step S107.

First, the color image of the barcode is divided into smaller regions using the multiple locators 12, so that each region is defined by four locators at its corners (step S108). For example, the barcode shown in FIG. 1, which has 4×4 locators, will be divided into nine regions. These regions may have different perspective distortion, e.g. if the printed sheet was not flat when the barcode image was captured. For each region, a transformation (projection) is applied to the region to transform it to its original shape as defined by the barcode layout design, such as a square with horizontal and vertical sides (step S109). In this step, the coordinates of the four locators that defined the region are used to compute the transformation, i.e. one that transforms the four locators to the four corners of the original shape (e.g. a square), and the computed transformation is then applied to the entire region. Then, all of the transformed regions are spatially combined together to generate a transformed barcode image (step S110). This barcode image will have the shape of the original layout, such as a square.

Because the barcode image is captured using a barcode reader or camera, the pixel intensities of the image are affected by lighting conditions and other conditions which may cause the pixel intensities to be non-uniform across the barcode. Thus, in steps S111 to S113, pixel intensity correction is applied to the barcode image, again using the locators 12. This process is applied to the transformed color barcode image obtained in step S110.

First, the average pixel intensity of the black pixels of each locator 12 is computed (step S111). A 2D illumination correction map, which consists of an illumination correction function for each pixel position of the barcode image, is constructed using the positions and the average pixel intensities of the locators of the barcode (step S112). More specifically, the illumination correction function for the pixel position of each locator (defined by its center) is a function that maps the average pixel intensity of that locator to the pixel value of ideal black; at each pixel position other than the locators, the illumination correction function is derived using 2-dimensional linear interpolation based on the illumination correction functions at the positions of nearby locators.

In a preferred embodiment, where the ideal black value is the maximal pixel value of the color image (e.g. 255 for 8-bit data), the illumination correction function at the pixel position of each locator is a multiplier which, when applied to the average pixel intensity of that locator, gives the ideal pixel value for black. In other words, the multiplier is the ratio of the pixel value for ideal black to the average pixel intensity of that locator. At each pixels position other than the locators, the illumination correction function is a multiplier whose value is computed by 2-dimensional linear interpolation from the multiplier values at nearby locator positions (e.g. the four nearby locators). Thus, such a 2D illumination correction map is a 2D map having the same size as the barcode image, and the pixel values of the 2D map are the multiplier values calculated in the above described manner.

Note here that in this example the definition of black and white is such that ideal black has the maximal pixel value. The pixel values of ideal black and white are a matter of definition. If a different definition is used where ideal black has a pixel value zero, then the illumination correction function at the pixel position of each locator will be one that maps the average pixel intensity of that locator to zero, and again the illumination correction function for pixel positions other than the locator are derived using 2-dimensional linear interpolation. This is mathematically equivalent to the example where the definition of black is the maximal pixel intensity.

After the illumination correction map is constructed, it is applied to the color barcode image (step S113). In other words, the illumination correction function for each pixel position is applied to the pixel value of the barcode image at that pixel position. In the above preferred embodiment, the pixel value of each pixel of the barcode imaged is multiplied by the corresponding multiplier of the 2D illumination correction map. This correction is separately applied to each color channel of the pixel value. As a result, an illumination-corrected color barcode image is generated.

The result of perspective distortion correction (steps S108-S110) and illumination correction (steps S111-S113) is a corrected barcode. After these corrections, a decoding process is applied to extract the color data of the data cells and decode the extracted data (step S114). Any suitable decoding method may be used to extract the color data of the data cells; one example is described in commonly owned U.S. patent application Ser. No. 14/290595, filed May 29, 2014.

In the illustrated embodiment, sixteen locators are located in the corners, along the borders and inside the barcode. In other barcode designs, different numbers and distributions of locators may be used, depending on the size of the barcode. In some examples, four locators located at the corners of the barcode may be sufficient.

The above-described barcode image processing method has the following features: First, if uses multiple binarization of the grayscale image to generate multiple binary images in order to identify all locators. Second, it applies illumination correction to the barcode image. More specifically, it uses multiple locators distributed throughout the barcode to calculate an illumination correction map which is then applied to the entire barcode. These features are motivated by the fact that the data cells are color cells and are small, and image quality of camera-captured barcode images is often low.

The color barcode image processing methods described here can be implemented in a data processing system such as a computer 120 as shown in FIG. 5. The computer 120 comprises a processor 121, a storage device (e.g. hard disk drive) 122, and an internal memory (e.g. a RAM) 123. The storage device 122 stores software programs, which are read out to the RAM 123 and executed by the processor 121 to carry out the methods. In one aspect, the invention is a method carried out by a data processing system. In another aspect, the invention is computer program product embodied in computer usable non-transitory medium having a computer readable program code embedded therein for controlling a data processing apparatus to carry out the method. In another aspect, the invention is embodied in a data processing system.

It will be apparent to those skilled in the art that various modification and variations can be made in the color barcode image processing method and related apparatus of the present invention without departing from the spirit or scope of the invention. Thus, it is intended that the present invention cover modifications and variations that come within the scope of the appended claims and their equivalents.

1. A method for processing a two-dimensional color barcode in a captured barcode image, the barcode having a known layout including a plurality of color data cells and a plurality of locators each formed of a plurality of black pixels, the locators being located at different positions throughout the barcode, the method comprising:
converting the color barcode image into a grayscale barcode image;
binarizing the grayscale barcode image a plurality of times, each time using one of a plurality of different binarization thresholds, to generate a plurality of binary images;
identifying locators in each of the plurality of binary images and determining their positions to generate a list of locators for each binary image; and
combining the plurality of lists of locators respectively identified in the plurality of binary images to generate a combined list of locators.

2. The method of claim 1, further comprising, before the binarizing step:
determining a maximal and a minimal intensity of the grayscale image; and
calculated the plurality of binarization thresholds based on the maximal and minimal intensities.

3. The method of claim 1, wherein the locators have a shape of concentric squares, wherein the step of identifying locators in each binary image comprises identifying ratios among consecutive horizontal runlengths of black and white pixels that fall within predetermined ranges.

4. The method of claim 3, wherein the step of identifying locators in each binary image further comprises:
identifying a plurality of candidate positions as possible positions of the locators;
for each of the plurality of candidate positions, identifying contours around the candidate position, and analyzing the contours to determine whether the candidate position is the position of a locator of the barcode.

5. A computer program product comprising a computer usable non-transitory medium having a computer readable program code embedded therein for controlling a data processing apparatus, the computer readable program code configured to cause the data processing apparatus to execute a process for processing a two-dimensional color barcode in a captured barcode image, the barcode having a known layout including a plurality of color data cells and a plurality of locators each formed of a plurality of black pixels, the locators being located at different positions throughout the barcode, the process comprising:
converting the color barcode image into a grayscale barcode image;
binarizing the grayscale barcode image a plurality of times, each time using one of a plurality of different binarization thresholds, to generate a plurality of binary images;
identifying locators in each of the plurality of binary images and determining their positions to generate a list of locators for each binary image; and
combining the plurality of lists of locators respectively identified in the plurality of binary images to generate a combined list of locators.

6. The computer program product of claim 5, wherein the process further comprises, before the binarizing step:
determining a maximal and a minimal intensity of the grayscale image; and
calculated the plurality of binarization thresholds based on the maximal and minimal intensities.

7. The computer program product of claim 5, wherein the locators have a shape of concentric squares, wherein the step of identifying locators in each binary image comprises identifying ratios among consecutive horizontal runlengths of black and white pixels that fall within predetermined ranges.

8. The computer program product of claim 7, wherein the step of identifying locators in each binary image further comprises:
identifying a plurality of candidate positions as possible positions of the locators;
for each of the plurality of candidate positions, identifying contours around the candidate position, and analyzing the contours to determine whether the candidate position is the position of a locator of the barcode.

9. The method of claim 1, wherein the step of combining the locators includes comparing positions of the locators in the plurality of lists identified from the plurality of binary images to determine whether some locators in different lists correspond to the same locators of the barcode.

10. The computer program product of claim 5, wherein the step of combining the locators includes comparing positions of the locators in the plurality of lists identified from the plurality of binary images to determine whether some locators in different lists correspond to the same locators of the barcode.
